(19) United States
(12) Patent Application Publication
(10) Pub. No.: US 2025/0353610 A1
(43) Pub. Date: Nov. 20, 2025

(54) FLYING OBJECT WITH FARADAY CAGE

(71) Applicant: Nippon Telegraph and Telephone Corporation, Tokyo (JP)

(72) Inventors: Toshihisa MASUDA, Musashino-shi, Tokyo (JP); Masato MARUYAMA, Musashino-shi, Tokyo (JP); Atsushi NAGAO, Musashino-shi, Tokyo (JP); Takashi IKEDA, Musashino-shi, Tokyo (JP)

(21) Appl. No.: 18/868,225

(22) PCT Filed: Jun. 6, 2022
(86) PCT No.: PCT/JP2022/022802

§ 371 Date: Nov. 22, 2024

(51) Int. Cl. B64D 45/02; B64U 30/294

(52) U.S. Cl. CPC B64D 45/02; B64U 30/294

(57) ABSTRACT

A drone with a Faraday cage includes a lattice-shaped conductor configured to expose the propellers to the outside and surround the drone body (control unit), a lightning rod disposed on the conductor and configured to avoid a direct lightning stroke on the propellers, an insulating attachment portion configured to attach the conductor to the drone, and a guide line configured to connect the conductor and the control facility on the ground.

### TECHNICAL FIELD

The present invention relates to a flight vehicle with a Faraday cage.

### BACKGROUND ART

Non Patent Literatures 1 and 2 disclose a technology of guiding a lightning strike to a safe place by using a drone. In Non Patent Literature 2, lightning countermeasures are taken on the drone to prevent the drone from crashing due to a direct lightning stroke.

### CITATION LIST

### Non Patent Literature

Non Patent Literature 1: “Lightning control and charging technology” [online] December 3, 2021, Nippon Telegraph and Telephone Corporation, Internet <URL:https://www.rd.ntt/research/SE0010.html>
Non Patent Literature 2: Toshihisa Masuda, and three others, “Drone no tairaisei kojo ni kansuru kisoteki kento (in Japanese) (Basic Study on Improvement of Lightning Resistance of Drones)”, The Institute of Electronics, Information and Communication Engineers, Society Convention, 2021 B-4-6, p. 176

### SUMMARY OF INVENTION

### Technical Problem

In Non Patent Literature 2, specifically, a Faraday cage surrounding the entire drone is provided to cope with lightning. Therefore, the drone can continue flying even after the lightning stroke.

However, since a drone with a Faraday cage in the related art is surrounded by the Faraday cage up to the outside of the propeller, there is a problem that the Faraday cage becomes a sphere considerably larger than the size of the drone body. As the Faraday cage becomes larger, the following problems exist for the transportation of the drone, the flight time of the drone, and the cost.

First, when transporting the drone mounted on a vehicle, a large transportation space is required. Since the drone cannot be transported by a small vehicle and is transported by a large vehicle, a place where the vehicle can enter is limited. Furthermore, there is a possibility that the Faraday cage is caught on the doorway and the cage is deformed when being carried into the vehicle from the warehouse.

It is considered that a longer flight time can cause more lightning strikes to occur, and thus the longer flight time is preferable. As the loaded weight of the drone increases, the flight time of the drone decreases. The surface area increases as the Faraday cage is larger. Therefore, it is more affected by wind. When a thundercloud is approaching, a considerable strong wind blows. When the drone moves against the wind, more power is consumed, and thus the flight time is reduced.

In terms of cost, the material required to make the Faraday cage increases proportionally to the size of the Faraday cage, which is costly. Furthermore, it takes time to perform a repair. Moreover, a large storage space is required, and the storage cost increases.

The present invention has been made in view of the above-described problems, and an object thereof is to reduce the size and weight of a drone with a Faraday cage.

### Solution to Problem

According to an aspect of the present invention, there is provided a flight vehicle including a propeller, the flight vehicle including: a lattice-shaped conductor configured to expose the propeller to an outside and surround a control unit of the flight vehicle; a lightning rod disposed on the conductor and configured to avoid a direct lightning stroke on the propeller; an insulating attachment portion configured to attach the conductor to the flight vehicle; and a conducting line configured to connect the conductor and a ground contact point.

### Advantageous Effects of Invention

According to the present invention, it is possible to reduce the size and weight of the drone with a Faraday cage.

### BRIEF DESCRIPTION OF DRAWINGS

FIG. 1 is a front view illustrating an example of a drone with a Faraday cage according to the present embodiment.

FIG. 2 is a top view illustrating an example of a drone with a Faraday cage according to the present embodiment.

### DESCRIPTION OF EMBODIMENTS

Hereinafter, an embodiment of the present invention will be described with reference to the drawings.

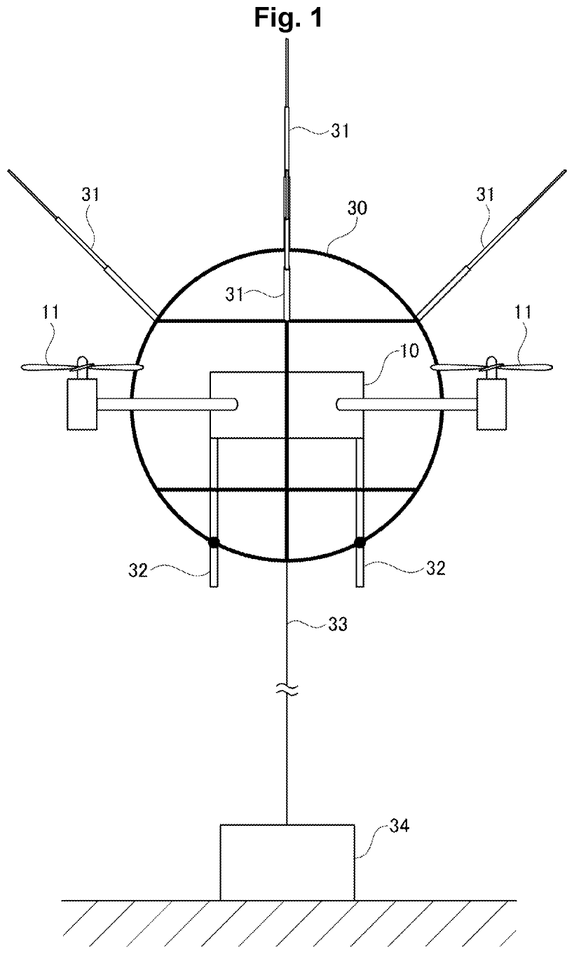

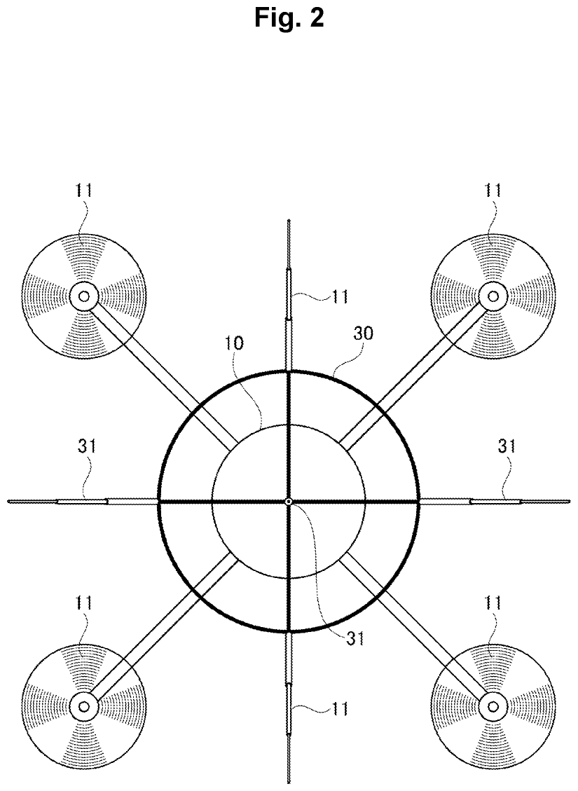

FIG. 1 is a front view illustrating an example of a drone with a Faraday cage according to the present embodiment, and FIG. 2 is a top view. The drone with a Faraday cage illustrated in FIGS. 1 and 2 is constituted by a drone and a Faraday cage.

The drone includes a drone body 10 and four propellers 11 disposed outside the drone body 10. A control unit for controlling the drone to fly is provided in the drone body 10.

The Faraday cage includes a conductor 30, a lightning rod 31, an attachment portion 32, a guide line 33, and a control facility 34.

The conductor 30 is disposed outside the periphery of the drone body 10 without including the propellers 11. The conductor 30 is a conductor that covers a control unit of the drone and receives a lightning stroke instead of the drone. As illustrated in FIGS. 1 and 2, the conductor 30 has a lattice shape. For example, the conductor 30 includes at least two ring-shaped wires. The overall shape of the conductor 30 is, for example, an elliptical shape, a spherical shape, or a rectangular shape.

The lightning rod 31 is disposed on each of the top portion and the horizontal portion of the conductor 30. In the examples of FIGS. 1 and 2, one lightning rod is disposed on the top portion of the conductor 30 and four lightning rods 31 are disposed on the horizontal portion. The length and arrangement of the lightning rods 31 are designed by a method of designing the lightning rod (for example, a rotating sphere method or the like) to avoid a direct lightning stroke on the propellers 11 exposed outside the conductor 30.

The lightning rod 31 is preferably extendable and retractable. By retracting the lightning rod 31 at the time of storage and transportation and extending the lightning rod 31 immediately before flight, it is possible to improve the transportability at the time of moving from the storage space.

By combining the conductor 30 and the lightning rod 31, it is possible to reduce the size and weight of the Faraday cage and to prevent an electromagnetic field generated by the lightning and a direct lightning stroke on the propellers 11. When the lightning strike occurs on the conductor 30 or the lightning rod 31, the electric shock current is shunted by the conductor 30, and the electric fields caused by the currents cancel each other inside the lattice-shaped conductor 30. Therefore, the influence of the electric shock current on the control unit of the drone can be extremely reduced.

The attachment portion 32 is an insulating rod member for attaching the conductor 30 to the drone. In the example of FIG. 1, the leg of the drone is used as the attachment portion 32.

The guide line 33 is a conductor cable for causing a lightning stroke current received by the conductor 30 to flow to the ground. The guide line 33 connects the lower portion of the conductor 30 and the input end of the control facility 34 on the ground.

The control facility 34 is a facility for controlling the lightning stroke current flowing through the guide line 33. The control facility 34 is installed on the ground. The control facility 34 is, for example, a lightning stroke current cutoff device, a lightning rod, a structure on the ground, or a ground. The control facility 34 is only required to be a ground contact point. A charging facility may be used as the control facility 34 to charge lightning energy.

As described above, the drone according to the present embodiment includes the lattice-shaped conductor 30 configured to expose the propellers 11 to the outside and surround the drone body 10 (control unit), the lightning rod 31 disposed on the conductor 30 and configured to avoid a direct lightning stroke on the propellers 11, the insulating attachment portion 32 configured to attach the conductor 30 to the drone, and the guide line 33 configured to connect the conductor 30 and the control facility 34 on the ground. According to this, it is possible to reduce the size and weight of the drone with a Faraday cage. Furthermore, the lightning rod 31 can be expanded and retracted, and thus the transportability can be improved.

### REFERENCE SIGNS LIST

10 Drone body
11 Propeller
30 Conductor
31 lightning rod
32 Attachment portion
33 Guide line
34 Control facility

1. A flight vehicle including a propeller, the flight vehicle comprising:
a lattice-shaped conductor configured to expose the propeller to an outside and surround a control unit of the flight vehicle;
a lightning rod disposed on the conductor and configured to avoid a direct lightning stroke on the propeller;
an insulating attachment portion configured to attach the conductor to the flight vehicle; and
a conducting line configured to connect the conductor and a ground contact point.

2. The flight vehicle according to claim 1,
wherein the lightning rod is extendable and retractable.

3. The flight vehicle according to claim 1,
wherein the lightning rod is disposed on a top portion and a horizontal portion of the conductor.

4. The flight vehicle according to claim 2,
wherein the lightning rod is disposed on a top portion and a horizontal portion of the conductor.
